(19) United States
(12) Patent Application Publication
(10) Pub. No.: US 2007/0176768 A1
(43) Pub. Date: Aug. 2, 2007

(54) Thermocouple microwave power sensor

(76) Inventor: Jonathan B. Scott, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/345,119

(22) Filed: Jan. 31, 2006

(51) Int. Cl. G08B 1/08

(52) U.S. Cl. 340/539.1

(57) ABSTRACT

A RF signal power detector includes a first and a second thermocouple unit coupled on a unitary substrate. Each thermocouple unit includes at least one pair of thermocouples and a resistor that are electrically isolated. The power is read across the thermocouple units.

### BACKGROUND

A thermocouple microwave power sensor detects the power of a wide-band RF signal. Thin Film and Monolithic thermocouples have been used for power measurements. Thermocouple microwave power sensors suffer from a susceptibility to burn out at higher power levels, parasitic reactances that limit their frequency range, and nonlinear thermocouple response. Typical thermocouple power sensors (shown schematically in FIGS. 1A and 1B) are disclosed by Jackson in Hewlett Packard Journal, September 1974, Vol. 26, No. 1, “A Thin-Film/Semiconductor Thermocouple for Microwave Power Measurements”, by Kodato in U.S. Pat. No. 6,518,743, “Wide-band RF signal power detecting element and power detecting device using the same”, and by Delfs, et al. in U.S. Pat. No. 4,789,823, “Power sensor for RF power measurements”.

As shown in FIG. 1A, Jackson uses capacitors to separate the incoming RF (AC) and outgoing measurable (DC) signals. As shown in FIG. 1B, the power dissipating resistor is isolated from the thermocouples, and a capacitor to block incoming DC is optional (not shown). Linearity correction is included in the controls of the power sensor as the accuracy degrades towards the high end of the meter.

In operation, one or more thermocouple pairs measure the temperature difference between two points. The temperature rise is assumed to be proportional to the unknown input power.

In some power sensors, a symmetrical arrangement of power dissipating elements and temperature sensors is used. In this “calorimetric” method, the DC power applied to one of the identical halves of the sensor arrangement is adjusted to match the unknown power applied to the other of the two identical halves of the sensor arrangement. When each of the two temperature sensors reads the same temperature, the known DC power applied is equal to the unknown RF power. A meter employing this method is disclosed by N. R. Erickson in “A fast and sensitive submillimeter waveguide power meter,” in Tenth Int. Space Terahertz Technol. Symp., Charlottesville, Va., March 1999, pp. 501-507.

### SUMMARY

An RF signal power detector includes one or more thermocouple units, forming a “thermopile”, and coupled on a unitary substrate. Each thermocouple unit consists of a pair of thermocouples in series, one nominally “hot”, and the other nominally “cold”. The RF signal power detector also includes two resistors that are electrically isolated from the thermopile. One resistor is positioned adjacent to the “hot” junctions of the thermopile, and the other is positioned adjacent to the “cold” junctions of the thermopile, in a symmetrical manner.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIGS. 1A and 1B illustrate prior art power sensors.

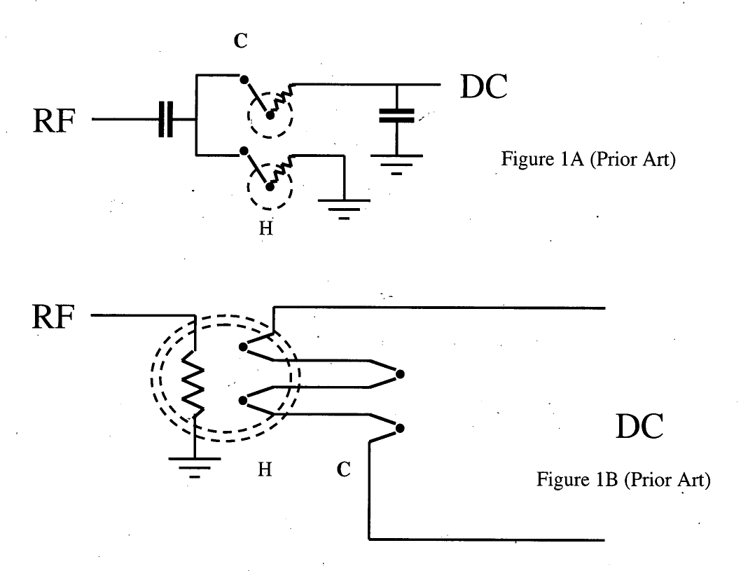

FIG. 2 illustrates an embodiment of the present invention.

FIG. 3 illustrates a schematic IC layout corresponding to the coupled thermocouple units shown in FIG. 2.

### DETAILED DESCRIPTION

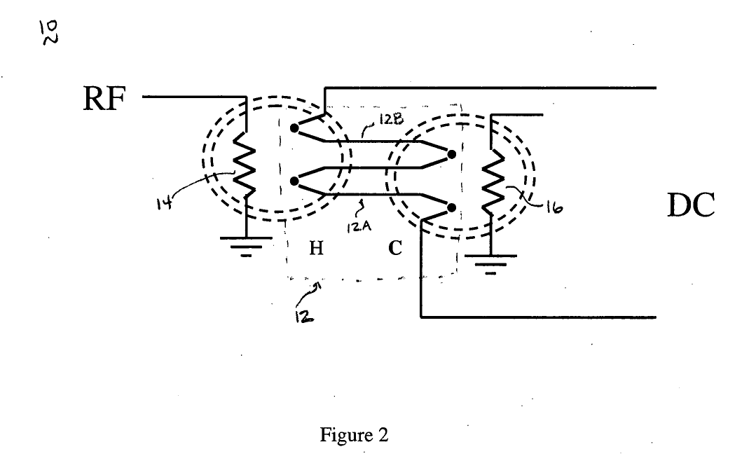

FIG. 2 shows an embodiment of the present invention. An RF signal power detector 10 includes one or more thermocouple units 12A, 12B, forming a so-called thermopile 12, and coupled on a unitary substrate. Each thermocouple unit 12A, 12B consists of a pair of thermocouples in series, one nominally “hot”, and the other nominally “cold”. The RF signal power detector 10 also includes two resistors 14, 16 that are electrically isolated from the thermopile 14. One resistor 14 is positioned adjacent to the “hot” junctions of the thermopile 12, and the other resistor 16 is positioned adjacent to the “cold” junctions of the thermopile 12, in a symmetrical manner.

The present invention is a thermocouple device that has two distinct modes of operation. When input RF power is small, the circuit operates in the conventional way, with input power causing a proportional rise in the temperature at the hot junctions, and a proportional DC output EMF appearing on the thermopile.

When input power increases, nonlinearity in thermocouple action and nonlinear material thermal properties can reduce the accuracy of the conventional method. In this case, the circuit may be used in “balance mode”, and the measurement is effected through a so-called calorimetric technique. In this mode, DC power is applied to the second, symmetrical resistor in order to drive the thermopile output voltage to zero, at which point the hot and the cold junctions of the thermopile are at the same temperature and the RF and DC powers are assumed to be equal. Since the thermopile voltage, representing the temperature difference between the “HOT” and “COLD” junctions is close to zero, thermocouple nonlinearity is eliminated. Since the two resistors are at equal temperature, material thermal nonlinearities are also balanced out. Thus the sensor requires no linearity correction and has greatly improved accuracy. An example of material thermal nonlinearity might be the temperature-dependent thermal conductivity of Gallium-Arsenide (GaAs).

In balance mode the ambient (true cold) temperature has no effect upon the measurement. This greatly reduces the effort associated with calibration of the sensor.

The two halves of the sensor may not be absolutely identical. Provided the asymmetries are small they can be corrected with a constant scalar multiplier.

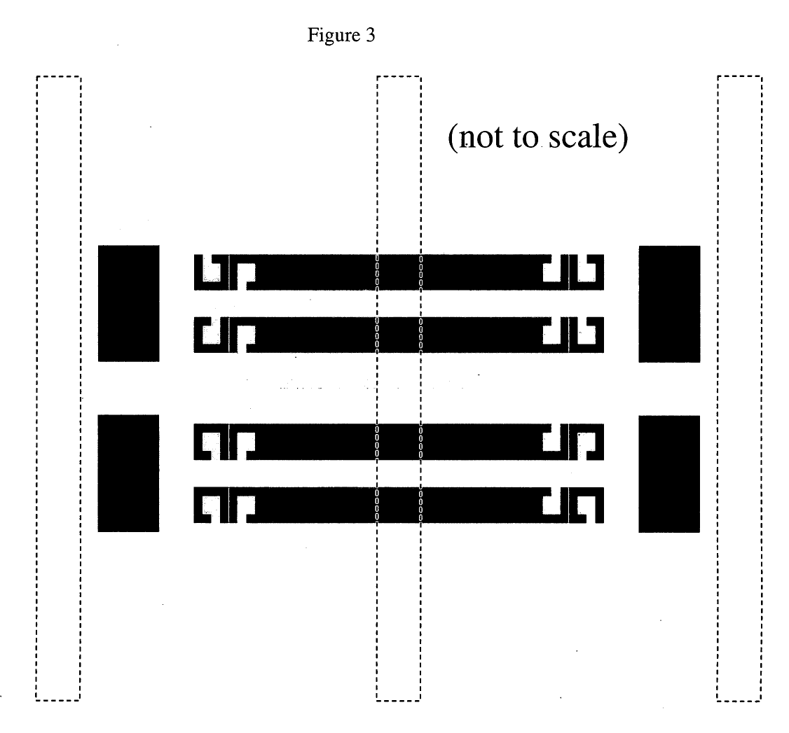

FIG. 3 illustrates a schematic IC layout corresponding to the first and second thermocouple units. The resistor of each unit is electrically isolated from its respective thermocouple pair. The thermocouple pairs are electrically connected. The substrate is a semiconductor. While in this embodiment, the layout is symmetrical. A small asymmetry is acceptable, e.g. the thermocouples need not be perfectly matched. The asymmetry may be within a few percent.

The invention may be used with good Standing Wave Ratio (SWR) to 110 GHz in coaxial cable or higher in waveguides because of physical separation of junctions from the load resistor enabled by use of III-V semiconductor system with high Seebeck coefficients.

As both power dissipating elements are built on the same integrated circuit, calibration of the thermocouple is not required. During operation, the DC power is applied until the difference between the thermocouple units reads “zero volts”. Thus, the sensor measures the power difference between two elements

Although the present invention has been described in detail with reference to particular embodiments, persons possessing ordinary skill in the art to which this invention pertains will appreciate that various modifications and enhancements may be made without departing from the spirit and scope of the claims that follow.

I claim:

1. A RF signal power detector comprising:
a thermopile, having an input and output, including,
one or more pairs of thermocouples connected in series, and
two resistors that are electrically isolated from the thermocouple unit.

2. A RF signal power detector, as in claim 1, wherein the thermocouples of the thermopile are integrated into a unitary substrate.

3. A RF signal power detector, as in claim 2, wherein the substrate and thermocouples include semiconductors.
